(19) United States
(12) Patent Application Publication
(10) Pub. No.: US 2006/0153992 A1
(43) Pub. Date: Jul. 13, 2006

(54) Method and device for hot-dip coating a metal bar

(76) Inventors: Bernhard Tenckhoff, Duisburg (DE); Holger Behrens, Erkrath (DE); Bodo Falkenhahn, Ratingen (DE); Michael Zielenbach, Siegen (DE); Rolf Brisberger, Issum (DE)

Correspondence Address: FRIEDRICH KUEFFNER, 317 MADISON AVENUE, SUITE 910, NEW YORK, NY, 10017, US

(21) Appl. No.: 10/535,772

(22) PCT Filed: Oct. 6, 2003
(86) PCT No.: PCT/EP03/11080

§ 371 Date: Jan. 17, 2006

(30) Foreign Application Priority Data
Nov. 21, 2002 (DE) 102 54 306.2

(51) Int. Cl. B05D 1/18; B05C 11/10; B05C 3/15

(52) U.S. Cl. 427/431; 118/693; 118/694; 118/405; 118/420; 118/429

(57) ABSTRACT

The invention relates to a method for hot-dip coating a metal bar (1), particularly a steel strip, according to which at least some sections of the metal bar (1) are vertically directed through a container (3) receiving the molten coating metal (2) at a given conveying speed (v). In order to influence the quality of the coating process, the time (t) during which the metal bar (1) remains in the molten coating metal (2) is predefined by controlling or regulating the surface level (h) of the molten coating metal (2) in the container (3). The invention also relates to a device for hot-dip coating a metal bar.

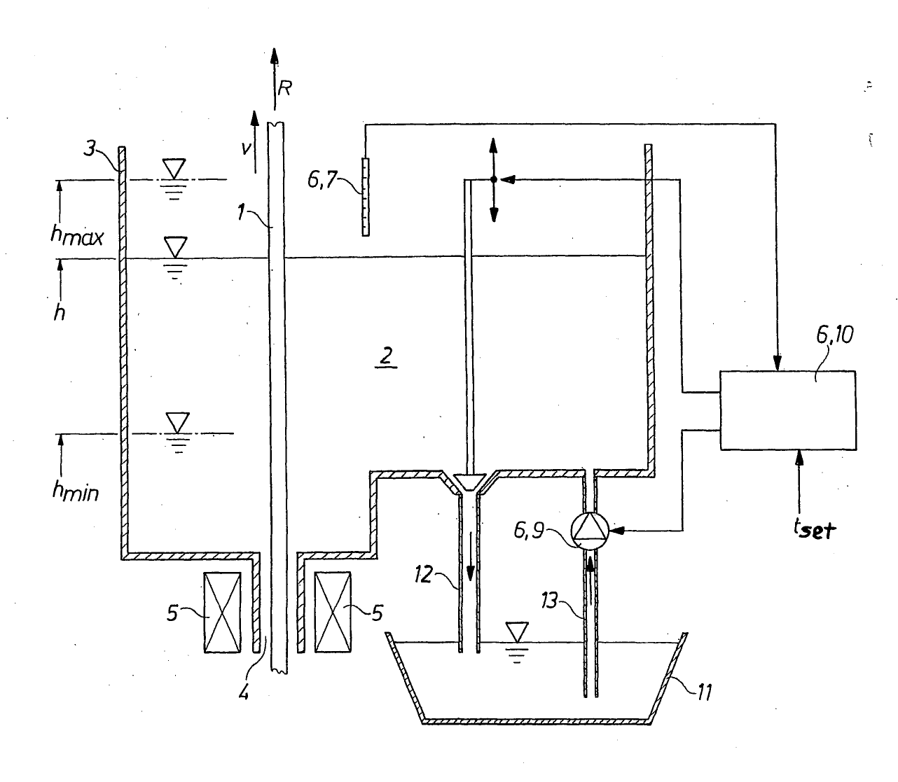

The invention concerns a method for hot dip coating a metal strand, especially a steel strip, in which at least some sections of the metal strand are passed vertically at a predetermined conveying speed through a coating tank that contains the molten coating metal. The invention also concerns a device for hot dip coating a metal strand.

Conventional metal hot dip coating installations for metal strip have a high-maintenance part, namely, the coating tank and the fittings it contains. Before being coated, the surfaces of the metal strip must be cleaned of oxide residues and activated for bonding with the coating metal. For this reason, the strip surfaces are subjected to heat treatments in a reducing atmosphere before the coating operation is carried out. Since the oxide coatings are first removed by chemical or abrasive methods, the reducing heat treatment process activates the surfaces, so that, after the heat treatment, they are present in a pure metallic state.

However, this activation of the strip surfaces increases their affinity for the surrounding atmospheric oxygen. To prevent the surface of the strip from being reexposed to atmospheric oxygen before the coating process, the strip is introduced into the hot dip coating bath from above in an immersion snout. Since the coating metal is present in the molten state, and since one would like to utilize gravity together with blowing devices to adjust the coating thickness, but the subsequent processes prohibit strip contact until the coating metal has completely solidified, the strip must be deflected in the vertical direction in the coating tank. This is accomplished with a roller that runs in the molten metal. This roller is subject to strong wear by the molten coating metal and is the cause of shutdowns and thus loss of production.

The desired low coating thicknesses of the coating metal, which vary in the micrometer range, place high demands on the quality of the strip surface. This means that the surfaces of the strip-guiding rollers must also be of high quality. Problems with these surfaces generally lead to defects in the surface of the strip. This is a further cause of frequent plant shutdowns.

To avoid the problems associated with rollers running in the molten coating metal, approaches have been proposed, in which a coating tank is used that is open at the bottom and has a guide channel in its lower section for guiding the strip vertically upward, and in which an electromagnetic seal is used to seal the open bottom of the coating tank. The production of the electromagnetic seal involves the use of electromagnetic inductors, which operate with electromagnetic alternating or traveling fields that seal the coating tank at the bottom by means of a repelling, pumping, or constricting effect.

A solution of this type is described, for example, in EP 0 673 444 B1. The solution described in WO 96/03,533 and the solution described in JP 50[1975]-86,446 also provide for an electromagnetic seal for sealing the coating tank at the bottom.

DE 42 08 578 A1 also describes a hot dip coating installation with an electromagnetic seal. To achieve a residence time of the metal strand in the coating metal that can be controlled independently of the running speed of the metal strand, this document proposes that, during the passage of the metal strand, the molten coating material is kept in a state of motion in the direction of the surface of the metal strand and circulated under conditions of air exclusion.

All of the proposed solutions cited above are basically focused on achieving a predetermined level of the coating metal in the coating tank. The running speed of the metal strand through the coating bath is generally used as an important parameter affecting the type and quality of the hot dip coating. Moreover, apart from the solution disclosed in DE 42 08 578 A1, there is usually no possibility of actively influencing the hot dip coating process. That is, in previously known hot dip coating methods, the residence time of the metal strand in the coating medium is usually dynamically varied by the running speed of the metal strand through the coating tank, since the level of the coating bath can be reduced only extremely slowly by the amount of coating metal being deposited on the metal strand. Accordingly, in this respect the level of the coating bath cannot be used as a dynamic correcting element for the adjustment of quality characteristics.

Methods for coating a substrate strip with silicon for solar cells or for semiconductor applications are known from U.S. Pat. No. 4,577,588 and U.S. Pat. No. 4,762,687.

In addition, EP 0 803 586 A1, U.S. Pat. No. 5,665,437, and DE 101 60 949 A1 describe hot dip coating methods and corresponding devices that employ an electromagnetic seal in the area of the base of the coating tank.

Therefore, the objective of the invention is to develop a method and a corresponding device for hot dip coating a metal strand, with which it is possible efficiently to control the parameters of the hot dip coating without the necessity of varying the running speed of the metal strand through the molten coating metal.

The method of the invention by which this objective is achieved is characterized by the fact that the conveying speed of the metal strand through the coating tank is held more or less constant and that the residence time of the metal strand in the molten coating metal is predetermined by automatic control or regulation of the height of the surface level of the molten coating metal in the coating tank, wherein the metal strand is guided exclusively vertically through the molten coating metal and through a guide channel upstream of the coating tank, and wherein an electromagnetic field is generated by means of at least two inductors installed on both sides of the metal strand in the area of the guide channel in order to keep the coating metal in the coating tank.

The idea of the invention is thus focused on using the surface level of the molten coating metal in the coating tank in order systematically to influence parameters that affect the quality of the hot dip coating process. This approach makes it possible to influence the coating quality without having to vary the conveying speed of the metal strand through the coating installation.

In this regard, the already well-known CVGL method (Continuous Vertical Galvanizing Line) with electromagnetic bottom sealing is used.

The device of the invention for hot dip coating a metal strand, in which at least some sections of the metal strand are passed vertically through the coating tank that contains the molten coating metal, is characterized by means for automatically controlling or regulating the height of the surface level of the molten coating metal in the coating tank as a function of a predetermined residence time of the metal strand in the molten coating metal, wherein the aforesaid means include measuring devices for measuring the level of the molten coating metal in the coating tank and means for controlling the level, which are connected to the automatic control or regulation system, and wherein the device has a guide channel upstream of the coating tank and at least two inductors installed on both sides of the metal strand in the area of the guide channel for generating an electromagnetic field for keeping the coating metal in the coating tank.

Furthermore, it can be provided that the means for controlling the level of the molten coating metal include an outlet for draining molten coating metal from the coating tank into a reservoir and a pump for pumping molten coating metal from the reservoir into the coating tank. In this regard, the reservoir is preferably installed below the coating tank.

To achieve the fastest and most efficient possible control of the surface level of the molten coating metal in the coating tank, it has been found to be effective for the capacity of the coating tank to be a fraction of the capacity of the reservoir. In this regard, it is provided, especially, that the capacity of the coating tank is 5-20% of the capacity of the reservoir.

A specific embodiment of the invention is illustrated in the drawing. The sole drawing shows a schematic representation of a hot dip coating device with a metal strand passed through it.

The device has a coating tank 3, which is filled with molten coating metal 2. The molten coating metal can be, for example, zinc or aluminum. The metal strand 1 to be coated is in the form of a steel strip. It passes vertically upward through the coating tank 3 in conveying direction R at a predetermined conveying speed v, which is held constant during the process.

It should be noted at this point that it is also basically possible for the metal strand 1 to pass through the coating tank 3 from top to bottom.

To allow passage of the metal strand 1 through the coating tank 3, the latter is open at the bottom, where a guide channel 4 is located. To prevent the molten coating metal 2 from flowing out at the bottom through the guide channel 4, two electromagnetic inductors 5 are located on either side of the metal strand 1. The electromagnetic inductors 5 generate a magnetic field, which produces volume forces in the liquid metal, and these forces counteract the weight of the coating metal 2 and thus seal the guide channel 4 at the bottom.

The inductors 5 are two alternating-field or traveling-field inductors installed opposite each other. They are operated in a frequency range of 2 Hz to 10 kHz and create an electromagnetic transverse field perpendicular to the conveying direction R. The preferred frequency range for single-phase systems (alternating-field inductors) is 2 kHz to 10 kHz, and the preferred frequency range for polyphase systems (e.g., traveling-field inductors) is 2 Hz to 2 kHz.

In the proposed hot dip coating device, the surface level h of the molten coating metal 2 in the coating tank 3 is actively influenced by suitable means, and the surface level h is systematically used to control the process parameters and thus the quality of the coating.

For this purpose, means 6 for automatically controlling or regulating the height h of the surface level are provided. The drawing shows that the surface level h can vary within large limits between a minimum surface level hₘᵢₙ and a maximum surface level hₘₐₓ.

The residence time t of the metal strand 1 in the coating metal 2 is determined by the current height h of the surface level in the coating tank and the conveying speed v. This in turn provides important control parameters for the hot dip coating process.

The means 6 for automatically controlling or regulating the height h of the surface level comprise first of all a measuring device 7 for measuring the current surface level h. The value measured by the measuring device 7 is supplied to an automatic control or regulation system 10, which also contains the desired value of the residence time t of the metal strand 1 in the coating metal 2. The automatic control or regulation system 10 can act on means 8, 9 for controlling the surface level h, namely, an outlet 8, through which molten coating metal 2 can be drained from the coating tank, and a speed-controlled pump 9, by which coating metal 2 can be pumped into the coating tank 3. The automatic control or regulation system 10 can automatically maintain the desired or required surface level h by suitably controlling the admission of coating metal 2 into the coating tank 3 or the draining of coating metal 2 from the coating tank 3.

It is especially advantageous if a reservoir 11 is installed below the coating tank 3. As is apparent from the present embodiment, a pipe 12 joins the outlet 8 with the reservoir 11. A pipe 13 is also provided. It contains a pump 9 for pumping coating metal 2 from the reservoir 11 into the coating tank 3.

The level of the coating bath is thus dynamically adjusted or automatically controlled by means of the outlet 8 and the pump 9. This makes it possible to use the surface level h as a manipulated variable for automatically controlling the quality of the coated metal strand 1.

Quality characteristics of the coated metal strand 1 downstream of the coating device can be adjusted or readjusted by systematic variation of the level h of the coating bath by means of the attendant variation of the residence time t of the metal strand 1 in the coating metal 2—at constant conveying speed v.

### LIST OF REFERENCE SYMBOLS

1 metal strand (steel strip)
2 coating metal
3 coating tank
4 guide channel
5 inductor
6 means for automatically controlling or regulating the height of the surface level
7 measuring device for measuring the surface level
8 means for controlling the surface level, outlet
9 means for controlling the surface level, pump
10 automatic control or regulation system
11 reservoir
12 pipe
13 pipe
v conveying speed
t residence time
h surface level of the molten coating metal in the coating tank
hₘᵢₙ minimum surface level
hₘₐₓ maximum surface level
R conveying direction

1. Method for hot dip coating a metal strand (1), especially a steel strip, in which at least some sections of the metal strand (1) are passed vertically at a predetermined conveying speed (v) through a coating tank (3) that contains the molten coating metal (2), wherein the conveying speed (v) of the metal strand (1) through the coating tank (3) is held more or less constant and that the residence time (t) of the metal strand (1) in the molten coating metal (2) is predetermined by automatic control or regulation of the height (h) of the surface level of the molten coating metal (2) in the coating tank (3), wherein the metal strand (1) is guided exclusively vertically through the molten coating metal (2) and through a guide channel (4) upstream of the coating tank (3), and wherein an electromagnetic field is generated by means of at least two inductors (5) installed on both sides of the metal strand (1) in the area of the guide channel (4) in order to keep the coating metal (2) in the coating tank (3).

2. Device for hot dip coating a metal strand (1), especially a steel strip, in which at least some sections of the metal strand (1) are passed vertically through a coating tank (3) that contains the molten coating metal (2), comprising means (6) for automatically controlling or regulating the height (h) of the surface level of the molten coating metal (2) in the coating tank (3) as a function of a predetermined residence time (t) of the metal strand (1) in the molten coating metal (2), wherein the means (6) include measuring devices (7) for measuring the level (h) of the molten coating metal (2) in the coating tank (3) and means (8, 9) for controlling the level (h), which are connected to the automatic control or regulation system (10), and wherein the device has a guide channel (4) upstream of the coating tank (3) and at least two inductors (5) installed on both sides of the metal strand (1) in the area of the guide channel (4) for generating an electromagnetic field for keeping the coating metal (2) in the coating tank (3).

3. Device in accordance with claim 2, wherein the means (8, 9) for controlling the level (h) of the molten coating metal (2) include an outlet (8) for draining molten coating metal (2) from the coating tank (3) into a reservoir (11) and a pump (9) for pumping molten coating metal (2) from the reservoir (11) into the coating tank (3).

4. Device in accordance with claim 3, wherein the reservoir (11) is installed below the coating tank (3).

5. Device in accordance with claim 3, wherein the capacity of the coating tank (3) is a fraction of the capacity of the reservoir (11).

6. Device in accordance with claim 5, wherein the capacity of the coating tank (3) is 5-20% of the capacity of the reservoir (11).
